(19) United States
(12) Patent Application Publication
(10) Pub. No.: US 2008/0252211 A1
(43) Pub. Date: Oct. 16, 2008

(54) Electroluminescent Lamp

(75) Inventors: Antonio Brunacci, Luxembourg (LU); Cecile Jouanique-Dubuis, Evrange (FR); Serge Kater, Luxembourg (LU)

Correspondence Address: CANTOR COLBURN, LLP, 20 Church Street, 22nd Floor, Hartford, CT, 06103, US

(73) Assignee: IEE INTERNATIONAL ELECTRONICS & ENGINEERING S.A., ECHTERNACH (LU)

(21) Appl. No.: 11/909,056

(22) PCT Filed: Mar. 21, 2006
(86) PCT No.: PCT/EP2006/060902

§ 371 Date: Sep. 18, 2007

(30) Foreign Application Priority Data
Mar. 21, 2005 (EP) 05102238.2

(51) Int. Cl. H01J 1/63; B05D 5/12

(52) U.S. Cl. 313/509; 427/66

(57) ABSTRACT

An EL lamp includes a substrate, which is transparent in at least a light-emitting region and an electrode assembly with a transparent electrode layer and a back electrode layer, which face each other in the light-emitting region. A phosphorescent layer and a dielectric layer are arranged between the transparent electrode layer and the back electrode layer. A first connection line is provided for connecting the transparent electrode to a driver circuit and a second connection line is provided for connecting the back electrode to a driver circuit. According to an important aspect of the invention, the EL lamp comprises an insulating layer for insulating the second connection line at least locally from the back electrode and/or, if the transparent electrode extends into a peripheral region of the EL lamp, for insulating the second connection line from the transparent electrode.

### TECHNICAL FIELD OF INVENTION

The present invention generally relates to an inorganic electroluminescent (EL) lamp and more particularly to the layered structure of such an inorganic EL lamp.

### BRIEF DESCRIPTION OF RELATED ART

EL lamps are increasingly used in functional lighting applications (e.g. displays, indicators or reading lamps) or ambient lighting applications (e.g. for car interiors).

FIG. 1 is an exploded view of the layered structure of a conventional inorganic EL lamp. The layered structure of an EL lamp usually comprises a transparent substrate 1 with a transparent electrode layer 2 formed thereon. In a light-emitting area of the EL lamp, a layer of phosphorescent material 3, e.g. ZnS, and a dielectric layer 4 are sandwiched between the transparent electrode 2 an a back electrode 5. The device is usually enclosed in some sealing or encapsulation material, which acts i.a. as moisture barrier layer. The transparent electrode and the back electrode are electrically connected to a driver ciruit by a first connection line 6 respectively a second connection line 7. This multi-layer structure of inorganic EL lamps is well known in the art.

By applying an alternating electric field, electrons in the phosphorescent material are excited to higher energy states. When these electrons return to lower energy states, visible light is emitted through the transparent layers. Light intensity can be controlled by the voltage and the frequency of the electric field applied by means of the driver circuit.

With regard to the processes for application of the layered structure, printing processes are used for the dielectric layer and the light-emitting layers. Concerning the transparent electrode, it is generally formed by coating the substrate with e.g. indium tin oxide (ITO). The transparent electrode can be deposited on the substrate in a sputtering process or an electron beam deposition process under vacuum conditions.

The electrodes are connected to the driver circuit by connection lines 6, 7, which contact the electrodes at the border of the light-emitting region as illustrated in FIG. 1. The conductivity of the connection lines is usually higher than the conductivity of the back electrode layer, which leads to a higher current density around the contact points and affects the local light intensity. Design freedom with regard to the topology of connection lines is hence restricted.

In order to avoid short-circuiting the two electrodes, the transparent electrode does not extend into the peripheral region around the light-emitting region. This is usually achieved by etching after or by masking during the deposition of the transparent electrode. Both alternatives are costly process steps. Etching furthermore requires the use of chemicals that have to be handled with care, and which are difficult to be disposed of.

Minimising the area of the ITO layer moreover requests specific patterning and highly precise application of the other layers, which is not obvious as the ITO layer itself is transparent.

### BRIEF SUMMARY OF THE INVENTION

The invention provides an inorganic EL lamp, which is easier to manufacture.

The invention further provides a method for producing an EL lamp.

An inorganic EL lamp comprises a substrate, which is transparent in at least a light-emitting region. The EL lamp is provided with an electrode assembly comprising a transparent electrode layer and a back electrode layer, which face each other in the light-emitting region. A phosphorescent layer, made e.g. of ZnS, and a dielectric layer made of a material with a high dielectric constant are arranged between the transparent electrode layer and the back electrode layer. A first connection line is provided for connecting the transparent electrode to a driver circuit and a second connection line is provided for connecting the back electrode to a driver circuit. According to an embodiment of the invention, the EL lamp comprises an insulating layer for insulating the second connection line at least locally from the back electrode and/or, if the transparent electrode extends into a peripheral region adjacent to the light-emitting region of the EL lamp, for insulating the second connection line from the transparent electrode, said insulating layer being selectively applied in specific regions along said second connection line on said back electrode and/or said transparent electrode layer.

The additional insulating layer, which is selectively applied in specific regions along the routing of the second connection line, insulates the second connection line at least locally from the layers underneath the second connection line. The second connection line hence can run across the graphite back electrode without contacting it over its entire length. The insulating layer can be patterned according to the routing of the second connection line or lines. It may have the shape of narrow stripes, which define the track of the second connection line. As a result, the design constraints concerning the routing of the second connection line are substantially relaxed: where an electrical contact with the underneath layer is not desired, e.g. at a crossing with the first connection line, the insulating layer can be applied.

As a further advantage, the transparent electrode layer can extend out of the light-emitting area into the peripheral region of the substrate. There is no need for etching the transparent electrode layer to provide space for the second connection line. Short-circuiting of the second connection line and the transparent electrode layer is avoided by the additional insulating layer. As etching requires the use of chemicals, which are difficult to use and to be disposed of, the ability to skip that production step will be highly appreciated. If the transparent electrode extends outwardly from the light-emitting region, requirements with regard to the precision of positioning the other layers can be relaxed. This may translate into a more cost-effective manufacturing process having a lower rejection rate.

The insulating layer may be printed onto the back electrode and/or the transparent electrode e.g. in a screen-printing process. Preferably, the insulating layer comprises patternable material such as a UV-curable, thermally curable or solvent-based ink, resin or blend of resins. The insulating layer is preferably made of a material having a high breakdown voltage. The materials of the insulating layer are advantageously chosen so as to be compatible with the other layers of the EL lamp, including an encapsulating layer. High environmental and thermal resistance and durability are other properties of the insulating layer, which contribute to stable properties of the EL lamp in various temperature and humidity conditions.

In a preferred embodiment of the invention, the EL lamp comprises at least two light-emitting regions, each of which is provided with a layered structure as described above. The insulating layer is shaped so as to provide an insulated track for connecting the at least two back electrodes by means of the second connection line. Such EL structures can be used for illuminating several individual lamps within a same circuit, e.g. a control panel of a car dashboard. In order to simplify the layout of the second connection line, the insulated track may extend through at least one of the light-emitting regions.

It will be noted that the layered structure disclosed hereabove is usually enclosed in some sealing or encapsulation material, which acts i.a. as moisture barrier layer.

It will further be appreciated that the selective application of the insulating layer in specific regions only of the back electrode and/or the transparent electrode layer entirely eliminates the need for etching steps during the manufacturing of the EL lamp. The insulating material is only applied in those regions, where insulation of the second connection line from the underlying layers is required. The present invention thus enables elimination of any etching step in the manufacturing process without loosing the possibility of having more than one light emitting area. Furthermore, the selective application of the insulating layer enables the easy manufacturing of EL lamps without restrictions regarding shape or size of the light emitting areas and without limitation as to the distance between light emitting areas on the same substrate.

The invention further concerns a method for manufacturing an electroluminescent lamp with at least one light-emitting region. A substrate having a transparent conductive layer applied thereupon is provided; the transparent conductive layer forms a transparent electrode in the light-emitting region. A first connection line is applied onto the substrate for connecting the transparent electrode with a driver circuit. In the light-emitting region of the EL lamp, a phosphorescent layer and a dielectric layer are applied onto the transparent electrode, and a back electrode is applied on top of the phosphorescent layer and the dielectric layer. An insulating layer is applied at least locally onto the back electrode and/or, in a peripheral region of the electroluminescent lamp, onto the transparent electrode. A second connection line is applied onto the insulating layer for connecting the back electrode with a driver circuit, e.g. in a screen-printing process.

### BRIEF DESCRIPTION OF THE FIGURES

The present invention will be more apparent from the following description not limiting embodiments with reference to the attached drawings, wherein

FIG. 1: is an exploded view of the layered structure of a conventional EL lamp;

FIG. 2: is an exploded view of the layered structure of an EL lamp in accordance with an exemplary embodiment of the present invention;

FIG. 3: is a top view of an EL lamp with two light-emitting regions.

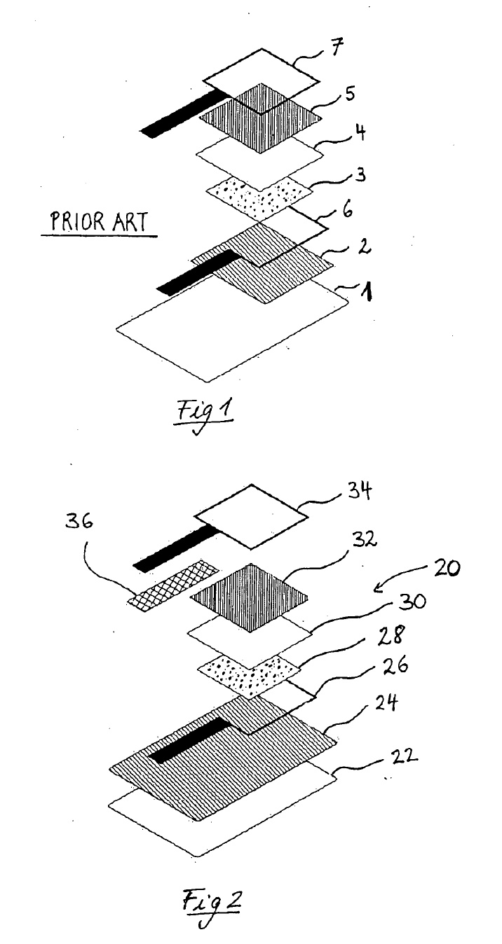

### DETAILED DESCRIPTION OF THE INVENTION

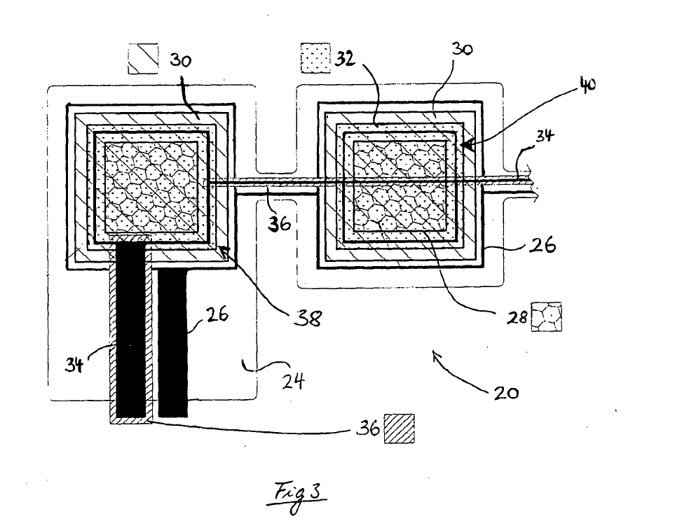

An exploded view of the layered structure of an EL lamp 20 is shown in FIG. 2. The layers of an EL lamp 20 include a transparent substrate 22, a surface of which has been coated with a transparent ITO electrode layer 24 in a vacuum evaporation process. The substrate 22 can e.g. be glass or a flexible material like a plastic foil. The transparent electrode layer 24 is electrically contacted by a first silver connection line 26 along the periphery of a light-emitting region, wherein a phosphorescent layer 28 is applied. A dielectric layer 30 with a high capacitance is arranged between the phosphorescent layer 28 and the back-surface graphite electrode 32. The back electrode 32 is electrically contacted by a second silver connection line 34, which also extends along the periphery of the light-emitting region. In order to insulate the second connection line 34, an insulating layer 36 is selectively arranged in specific regions underneath the second connection line 34. The function of the insulating layer 36 in this case is to separate the second connection line 34 locally from the back electrode 32 together with the dielectric layer 30 and entirely from the ITO layer 24. The material of the insulating layer 36 is different from the material of the dielectric layer 30 and has better insulation properties than the latter.

It will be appreciated that the ITO layer 24 can extend into the peripheral region, which surrounds the light-emitting region. The need for patterning the transparent electrode by masking or etching is hence eliminated, resulting in a considerable simplification of the manufacturing process of an EL lamp 20.

FIG. 3 shows a top view of an EL lamp 20 with at least two light-emitting regions 38, 40. The second connection line 34 diametrically crosses the light emitting region 40, without giving rise to brightness inhomogeneity, because the insulating layer 36 insulates the graphite electrode 32 from the connection line 34 in the region directly above the phosphorescent layer 28. The connection line 34 usually has a much higher conductivity than the back electrode 32, which results in an elevated current density in the back electrode at contact points with the connection line 34 and ultimately in brighter spots in the light-emitting region of the EL lamp.

The insulating layer 36 further insulates the second connection line 34 from the dielectric layer 30, where the latter is not covered with the second electrode layer 34. This prevents the passage of current towards the front electrode through the dielectric layer 30. This will be appreciated because high current densities can damage the dielectric layer 30 leading to defects known as “dark spots”.

Moreover, the insulating layer 36 insulates the second connection line 34 from the transparent electrode 24 and the first connection line 26. The transparent electrode layer 24 may hence extend laterally out of the light-emitting areas 38, 40 without short-circuiting with the second connection line 34. The substrate covered entirely on one of its surfaces with the transparent electrode 24 can be used as it is: there is no need for etching the transparent electrode 24.

The layout of the conductive lines 26, 34 is rendered easier, as crossings do not need to be avoided. In case of a crossing, the insulating layer 36 is arranged between the conductive lines 26, 34.

1.-11. (canceled)

12. An electroluminescent lamp with a light-emitting region comprising
a substrate, said substrate being transparent in at least said light-emitting region;
an electrode assembly with a transparent electrode layer and a back electrode layer, said back electrode layer facing said transparent electrode layer in said light-emitting region;
a phosphorescent layer and a dielectric layer arranged between said transparent electrode layer and said back electrode layer in said light-emitting region;
a first connection line for connecting said transparent electrode to a driver circuit and a second connection line for connecting said back electrode to a driver circuit; and
an insulating layer for insulating said second connection line at least locally from said back electrode, said insulating layer being selectively applied in specific regions along said second connection line on said back electrode.

13. Electroluminescent lamp according to claim 12, further comprising a peripheral region adjacent to said light-emitting region, wherein said transparent electrode layer extends into said peripheral region and wherein said insulating layer insulates said second connection line in said peripheral region from said transparent electrode layer, said insulating layer being selectively applied in specific regions along said second connection line on said transparent electrode layer.

14. Electroluminescent lamp according to claim 12, wherein said insulating layer comprises a UV-curable resin or ink.

15. Electroluminescent lamp according to according to claim 12, wherein said insulating layer is printed onto said back electrode and/or said transparent electrode.

16. An electroluminescent lamp according to according to claim 12, with at least two light-emitting regions, wherein said insulating layer is shaped so as to provide an insulated track for connecting said at least two back electrodes by means of said second connection line.

17. An electroluminescent lamp according to claim 16, wherein said insulated track extends through at least one of said light-emitting regions.

18. Electroluminescent lamp according to according to claim 12, further comprising a protective encapsulating layer applied on top of said back electrode and/or said second connection line.

19. An electroluminescent lamp with a light-emitting region comprising
a substrate, said substrate being transparent in at least said light-emitting region;
an electrode assembly with a transparent electrode layer and a back electrode layer, said back electrode layer facing said transparent electrode layer in said light-emitting region;
a phosphorescent layer and a dielectric layer arranged between said transparent electrode layer and said back electrode layer in said light-emitting region;
a first connection line for connecting said transparent electrode to a driver circuit and a second connection line for connecting said back electrode to a driver circuit;
wherein said electroluminescent lamp comprises a peripheral region adjacent to said light-emitting region, wherein said transparent electrode extends into said peripheral region, and an insulating layer for insulating said second connection line in said peripheral region from said transparent electrode, said insulating layer being selectively applied in specific regions along said second connection line on said transparent electrode layer.

20. Electroluminescent lamp according to claim 19, wherein said insulating layer is further selectively applied in specific regions along said second connection line on said back electrode for insulating said second connection line at least locally from said back electrode.

21. Electroluminescent lamp according to according to claim 19, wherein said insulating layer comprises a UV-curable resin or ink.

22. Electroluminescent lamp according to according to claim 19, wherein said insulating layer is printed onto said back electrode and/or said transparent electrode.

23. An electroluminescent lamp according to according to claim 19, with at least two light-emitting regions, wherein said insulating layer is shaped so as to provide an insulated track for connecting said at least two back electrodes by means of said second connection line.

24. An electroluminescent lamp according to claim 23, wherein said insulated track extends through at least one of said light-emitting regions.

25. Electroluminescent lamp according to according to claim 19, further comprising a protective encapsulating layer applied on top of said back electrode and/or said second connection line.

26. A method for manufacturing an electroluminescent lamp with at least one light-emitting region comprising:
providing a substrate having a transparent conductive layer applied thereupon, said transparent conductive layer forming a transparent electrode in said light-emitting region;
applying a first connection line onto said substrate for connecting said transparent electrode with a driver circuit;
applying a phosphorescent layer and a dielectric layer onto said transparent electrode in said light-emitting region;
applying a back electrode on top of said phosphorescent layer and said dielectric layer in said light-emitting region;
characterised by the steps of selectively applying an insulating layer in specific regions onto said back electrode and/or, in a peripheral region of said electroluminescent lamp, onto said transparent electrode and applying a second connection line onto said insulating layer for connecting said back electrode with a driver circuit, said insulating layer being selectively applied in specific regions along said second connection line.

27. Method according to claim 26, wherein said insulating layer is applied in a screen-printing process.
